(19) United States
(12) Patent Application Publication
(10) Pub. No.: US 2015/0212570 A1
(43) Pub. Date: Jul. 30, 2015

(54) COMPUTER SYSTEM AND CONTROL METHOD FOR COMPUTER SYSTEM

(71) Applicants: Masaki Hamamoto, Tokyo (JP); Masanao Yamaoka, Tokyo (JP)

(72) Inventors: Masaki Hamamoto, Tokyo (JP); Masanao Yamaoka, Tokyo (JP)

(73) Assignee: Hitachi, Ltd., Tokyo (JP)

(21) Appl. No.: 14/424,145

(22) PCT Filed: Sep. 3, 2012
(86) PCT No.: PCT/JP2012/072292

§ 371 Date: Feb. 26, 2015

(51) Int. Cl. G06F 1/32

(52) U.S. Cl. CPC G06F 1/3243

(57) ABSTRACT

In the related art, even in computation of an application which has a resistance to a computation error in a computer system, since the computation error is accurately corrected, there is a problem that a power supply voltage or an operating frequency for realizing lower power or a faster speed cannot be variable in a large manner.

In the invention, it is possible to solve the above-described problem by a computer system which includes a first processor and a second processor. In the first processor, at least one of an operating frequency or an operating voltage is variable. A detecting module which is operated by the second processor detects an error of the first processor. A determining module which is operated by the second processor determines at least one of the operating frequency or the operating voltage of the first processor.

### TECHNICAL FIELD

The present invention relates to a computer system, particularly to a control of a power supply voltage or an operating frequency.

### BACKGROUND ART

In recent years, it has been predicted that there would be an increasing number of applications requiring a large amount of computation, such as recognition processing or search processing which uses a large amount of data, and a computing machine having improved performance and needing low power would be required. However, in a semiconductor switching element which constitutes the computing machine, variations in static and dynamic characteristics increase as the semiconductor switching element becomes smaller, and it is difficult to improve performance of the computing machine in the future using a design based on the worst case in the related art.

In PTL 1, a technology, which uses a fact that a critical path of a circuit rarely becomes active and which sets the power supply voltage or the frequency based on error properties, is disclosed. In the technology disclosed in PTL 1, when an error is detected, the error is corrected to a correct value by re-computing.

### CITATION LIST

### Patent Literature

[PTL 1] JP-A-2006-520952

### SUMMARY OF INVENTION

### Technical Problem

For example, in learning processing or recognition processing, it is more important to be able to recognize whether or not a value is a person, rather than to obtain a computed value, such as 10.012 or 10.125, and there is a case where some computation errors do not have an influence which immediately causes breakdown of an application. In particular, in a computing method for obtaining an answer by converging computation results in an equilibrium state by computing repeatedly, a resistance with respect to the computation errors is extremely high since tolerance due to the computation errors disappears due to the repetition of the computation. In other words, there is an importance level in errors, and a standard of the importance level is different in each application. However, in order to consider that the errors have a uniform importance level in an approach of the technology in PTL 1, precise re-computing is performed even with respect to the errors having a low importance level. For this reason, there is a problem that it is not possible to greatly change a power supply voltage or an operating frequency.

Here, the invention is for providing a technology to make it possible to greatly change the power supply voltage or the operating frequency.

### Solution to Problem

In the invention, the above-described problem is solved by a computer system which includes a first processor and a second processor. In the first processor, at least one of an operating frequency or an operating voltage is variable. A detecting module which is operated by the second processor detects an error of the first processor. A determining module which is operated by the second processor determines at least one of the operating frequency or the operating voltage of the first processor.

### Advantageous Effects of Invention

It is possible to set a large range of variation in a power supply voltage or a frequency.

### BRIEF DESCRIPTION OF DRAWINGS

FIG. 1 is a functional block diagram of a computer system which is an embodiment of the invention.

FIG. 2 is an example of information which is included in a program 102.

FIG. 3 is a diagram illustrating an example of a hardware configuration of the computer system which is the embodiment of the invention.

FIG. 4 is a diagram illustrating an example of a control region of a power supply voltage and an operating frequency in a computing unit 321.

FIG. 5 is an example of a system operation flow chart of a computer system 100.

FIG. 6 is a diagram illustrating an example of a process of inserting error detection processing information 220 and correction processing information 230 into main computation processing information 205.

FIG. 7 is an example of a computing operation flow chart of the computer system 100.

FIG. 8 is an example of a flow chart which corresponds to processing from error detection processing S702 to log output processing S711.

FIG. 9 is a diagram illustrating an example of a progress of a computation result X in times of repetition of repeated converging computation.

FIG. 10 is a system configuration diagram of a computer system 1001 which is the embodiment of the invention.

### DESCRIPTION OF EMBODIMENTS

Hereinafter, an embodiment will be described with reference to the drawings.

### Embodiment 1

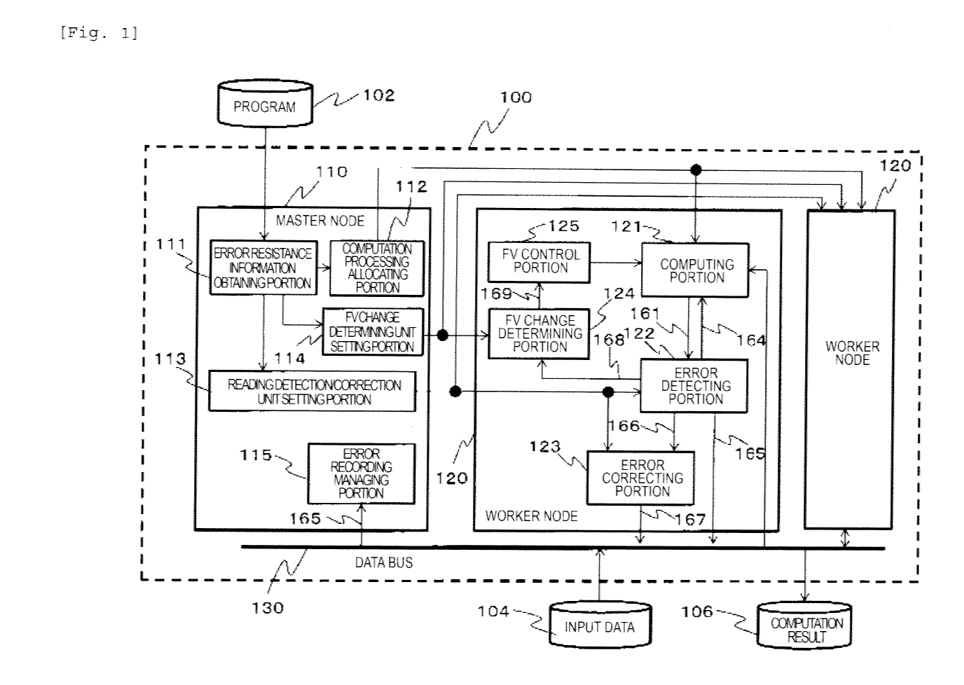

In the embodiment, an example of a computer system which can perform computation with low power or a high speed corresponding to reliability required by an application, will be described. FIG. 1 is a functional block diagram of a computer system 100 which is the embodiment of the invention.

The computer system 100 is a system which outputs a computation result 106 with respect to an input program 102 and input data 104, and includes a master node 110, one or more worker nodes 120, and a data bus 130.

The master node 110 includes an error resistance information obtaining portion 111, a computation allocating portion 112, an error detection/correction method setting portion 113, an FV change determining unit setting portion 114, and an error recording managing portion 115. The master node 110 has a function of obtaining computation processing information which is a target to be solved, and error resistance information which is related to a detecting unit and a correcting unit of a computation error, from the program 102 which is an execution target, and a function of allocating these pieces of information to the worker node 120. In addition, the master node 110 has a function of performing a basic computation control in parallel processing, such as barrier synchronization processing while the worker node 120 executes the computation processing.

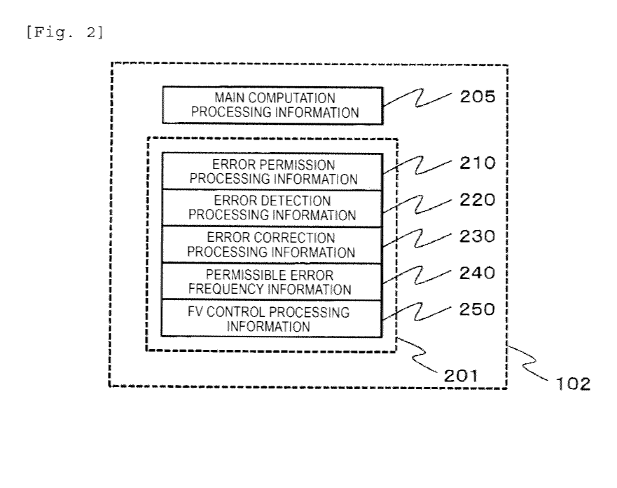

The error resistance information obtaining portion 111 obtains main computation processing information 205 of the application from the program 102, and computation error resistance information 201 in the computation processing. An example of the information included in the program 102 is illustrated in FIG. 2. The program 102 includes the main computation processing information 205 and the computation error resistance information 201 in the computation processing. The main computation processing information 205 is a computation processing program which is a target to be solved by the application. The computation error resistance information 201 is information which is related to resistance of the application with respect to the computation error.

The computation error resistance information 201 includes error permission processing information 210, error detection processing information 220, error correction processing information 230, permissible error frequency information 240, and FV control processing information 250.

The error permission processing information 210 is information which shows a computation processing part that has a resistance to the computation error inside the main computation processing information 205. Since most of the computation processing part that has a resistance to the computation error is repetitive computation which is described by a for sentence or the like, the program can designate the part by a directive.

The error detection processing information 220 is information regarding error detection processing for detecting a serious computation error at the computation processing part which is shown by the error permission processing information 210. Hereinafter, the serious computation error which is detected by the error detection processing is expressed as a user definition error. The error correction processing information 230 is information regarding error correction processing for correcting a computation result in which the user definition error is detected.

The permissible error frequency information 240 is information regarding a frequency of the user definition error which is permissible by the application. Examples thereof include the number of times of generation of the user definition error per a predetermined computation step period.

The FV control processing information 250 is information regarding control processing of at least any of the operating frequency or the power supply voltage of a computing portion 121 of the worker node 120. Example thereof includes a unit which controls one of the operating frequency and the power supply voltage, or both of them, based on the permissible error frequency information 240 and the frequency of the user definition error which is detected in the middle of the computation. A control target is determined according to operating mode setting information which is included in the FV control processing information 250. If the operating mode is a low power mode, the power supply voltage can be controlled by setting the operating frequency to be constant. If the operating mode is a fast processing mode, the operating frequency can be controlled by setting the power supply voltage to be constant. If the operating mode is a balanced operating mode, the operating frequency can be controlled to be increased or the like, by decreasing the power supply voltage so that the electric power is constant.

The computation processing allocating portion 112 allocates computation processing to be covered by each worker node with respect to each worker node 120. The error detection/correction unit setting portion 113 allocates the error detection processing information 220 to an error detecting portion 122 of each worker node 120, and allocates the error correction processing information 230 to an error correcting portion 123 of each worker node 120. The FV change determining unit setting portion 114 allocates the FV control processing information 250 to an FV change determining portion 124 of each worker node 120. The error recording managing portion 115 records a state of generation of the user definition error which is detected by the error detecting portion 122 of each worker node 120.

The worker node 120 includes the computing portion 121, the error detecting portion 122, the error correcting portion 123, the FV change determining portion 124, and an FV control portion 125.

The computing portion 121 performs the computation processing which is allocated from the computation processing allocating portion 112. The computing portion 121 obtains data which is necessary in computing from a storage device 340, from the input data 104 via the data bus 130, or from other worker nodes 120, computes the data, and outputs a computation result 161 to the error detecting portion 122.

The error detecting portion 122 detects the user definition error which is the serious computation error in the computation result of the computing portion 121, by using the information which is allocated by the error detection/correction unit setting portion 113 inside the detection processing information 220. When the user definition error is detected, the error detecting portion 122 outputs a re-computation request 164 to the computing portion 121, or correction request 166 with respect to the computation result to the error correcting portion 123. In addition, the error detecting portion 122 notifies that the user definition error is generated, to the FV change determining portion 124 by a user definition error generation notification 168, and further, outputs error log information 165, which is related to generation of the user definition error, to the error recording managing portion 115 of the master node 110.

The error correcting portion 123 corrects the computation result 161 of the computing portion 121 based on the correction request 166 from the error detecting portion 122, by using the information allocated by the error detection/correction unit setting portion 113 inside the error correction processing information 230. The error correcting portion 123 outputs a corrected computation result 167 to the data bus 130.

The FV change determining portion 124 determines whether to change at least any of the operating frequency or the power supply voltage of the computing portion 121, based on the information allocated by the FV change determining unit setting portion 114, and the user definition error generation notification 168 from the error detecting portion 122, inside the FV control processing information 250. When the FV change determining portion 124 determines that a change should be performed, the FV change determining portion 124 outputs a setting amount 169 of the operating frequency and the power supply voltage to the FV control portion 125.

The FV control portion 125 sets the operating frequency and the power supply voltage of the computing portion 121, based on the setting amount 169 from the FV change determining portion 124. The data bus 130 is a communication path for linking the master node 110, the one or more worker nodes 120, and further, other external apparatuses.

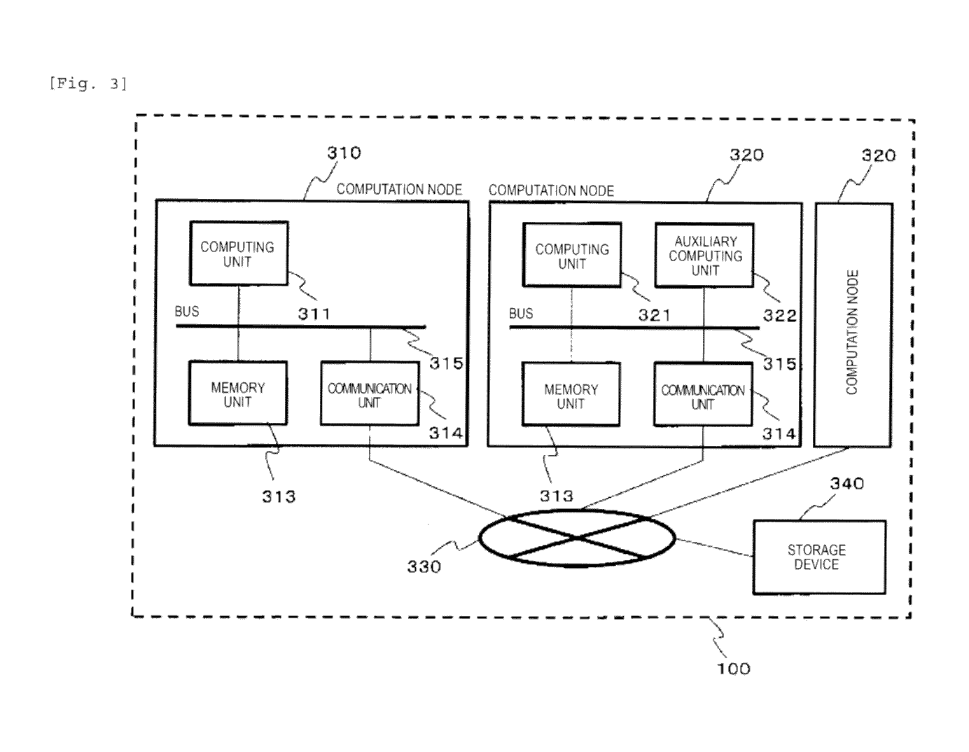

FIG. 3 illustrates an example of a hardware configuration of the computer system 100. The computer system 100 includes a computation node 310, at least one computation node 320, a network 330, and a storage device 340.

The computation node 310 is a computation node which realizes a function of the master node 110 illustrated in FIG. 1, and includes a computing unit 311, a memory unit 313, a communication unit 314, and a bus 315. The computation node 310 is an information processing device, for example, a sever device.

The computing unit 311 is a unit which performs reading-out computation of a program from the memory unit 313, and is realised by a central processing unit (CPU) or the like. The memory unit 313 is a unit which stores the program or the data, and is realized by a DRAM or the like. The communication unit 314 is a unit which performs an inter-node communication via the network 330. The bus 315 is a communication path for performing data communication between the units, such as the computing unit 311 or the memory unit 313, in the node.

The computation node 320 is a computation node which realizes a function of the worker node 120 illustrated in FIG. 1, and includes a computing unit 321, an auxiliary computing unit 322, the memory unit 313, the communication unit 314, and the bus 315. The computation node 320 may be provided with a plurality of computing units 321 or memory units 313. The computation node 320 is an information processing device, for example, a server device.

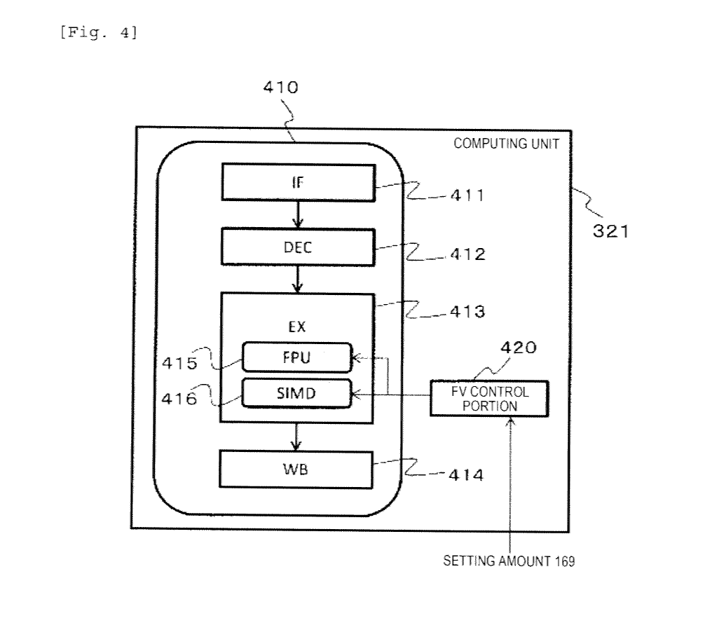

The computing unit 321 is a computing unit which realizes functions of the computing portion 121 and the FV control portion 125 which are illustrated in FIG. 1, and the power supply voltage and the operating frequency thereof can be set from the outside. FIG. 4 illustrates an example of a control region of the power supply voltage and the operating frequency in the computing unit 321. The computing unit 321 includes a CPU 410 and an FV control portion 420. The CPU 410 is configured of a processing block which performs command fetch processing 411, command decoding processing 412, calculating processing 413, and a writing-back processing 414. Here, in the CPU 410, in particular, it is possible to set the power supply voltage or the operating frequency of a calculating unit which computes data and a storing unit that are not related to the control of the program, such as a floating-point calculating (FPU) unit 415 or a data parallel calculating (SIMD) unit 416 which perform the calculating processing 413, in accordance with the setting amount 168 by the FV control portion 420. When an error is generated in computation which is related to the control of the program, such as a memory address or a pointer computation, there is a possibility that an obstacle, such as a hang-up of the computing unit 321, is generated. For this reason, by limiting a unit which controls the power supply voltage or the operating frequency in this manner, when an operation which causes the operation of the CPU 410 to be unstable, such as reduction of the power supply voltage while keeping the operating frequency constant is performed, it is possible to avoid the hang-up of the computing unit 321.

The auxiliary computing unit 322 is a programmable computing unit which is realized by the CPU or the like, and realizes functions of the error detecting portion 122, the error correcting portion 123, and the FV change determining portion 124 which are illustrated in FIG. 1. Since the auxiliary computing unit 322 performs only simple processing, it is possible to realize computation by a computing unit which has a lower processing performance compared to the computing unit 321. In addition, as the functions of the error detecting portion 122, the error correcting portion 123, and the FV change determining portion 124 are realized by another processor which is different from the processor that performs the control of the power supply voltage or the operating frequency by using the auxiliary computing unit 322, it is possible to prevent the operation of the computer system 100 from becoming unstable by the control of the power supply voltage or the operating frequency. For this reason, it is possible to perform control to more greatly change the power supply voltage or the operating frequency. When the part which controls the power supply voltage or the operating frequency by the computing unit 321 is not limited, the use of the auxiliary computing unit 322 is particularly effective in stabilizing the operation of the computer system 100.

The network 330 is a network which links the computation node 310, one or more computation nodes 320, and the storage device 340, and is configured of a network switch or the like. The storage device 340 is used for accommodating the data which is used in calculating by the program 102 or the computer system 100.

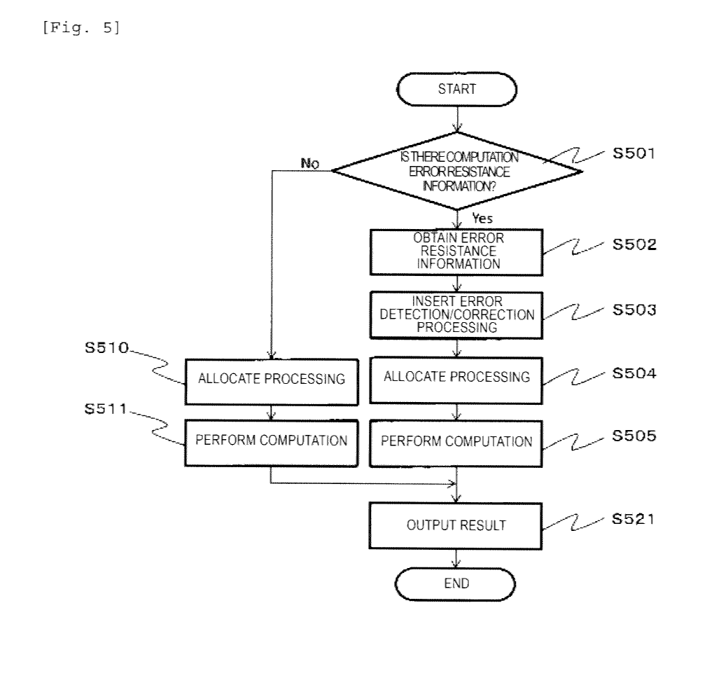

Next, operations of the computer system 100 will be described. FIG. 5 is an operation flow chart of a computer system 100.

First, the master node 110 confirms whether or not the program 102 includes the computation error resistance information 201, in step S501 for deciding whether there is presence or absence of the computation error resistance information. When the program 102 does not include the computation error resistance information 201, the master node 110 divides the main computation processing information 205 and allocates the main computation processing information 205 to the computing unit 321 of each worker node 120 (step S510) similarly to a general parallel computer system, executes the computation (step S511), and performs a result output (step S521).

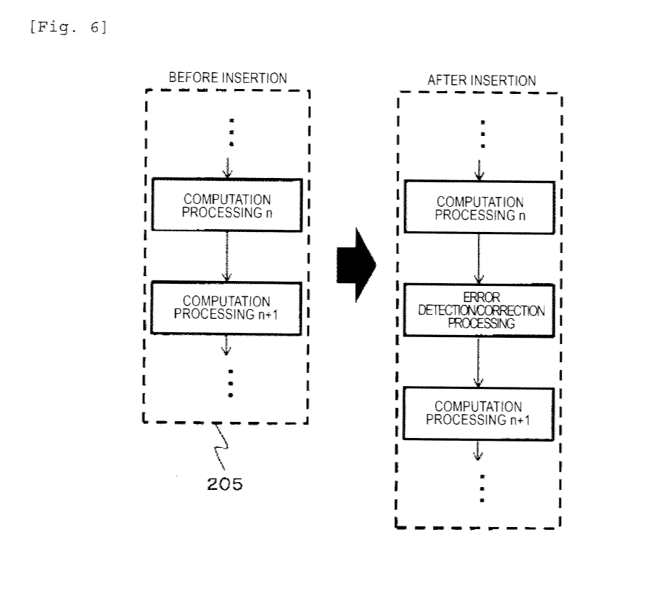

When the program 102 includes the computation error resistance information 201, the master node 110 obtains the computation error resistance information 201 (step S502), and inserts the detection processing information 220 and the error correction processing information 230 into a processing step of the main computation processing information 205 as illustrated in FIG. 6 (step S503). In FIG. 6, an example of inserting of the error detection processing and the error correction processing between the n-th computation processing and the n+1-th computation processing in the computation part shown by the error permission, processing information 210, is illustrated. Here, the n-th computation processing corresponds to computation processing which is the n-th time of repetition in computing for updating coordinates of a cluster center position, for example, in a K-means clustering algorithm. The operation of step S503 corresponds to setting of the computation result of the computing unit 321 to be output via the auxiliary computing unit 322. In addition, an insertion position of the error detection processing information 220 and the error correction processing information 230 is indicated by a directive or the like inside the main computation processing information 205. In step S504, the processing of the main computation processing information 205 is divided by the master node 110 which allocates the main computation processing information 205 to the computing unit 321 of each worker node 120, and further allocates the error detection processing information 220, the error correction processing information 230, and the FV control processing information 250 to the auxiliary computing unit 322 of each worker node 120.

In step S505, the computer system 100 executes the computation processing which is allocated to the worker node 120 in step S504, and outputs the computation result in step S521.

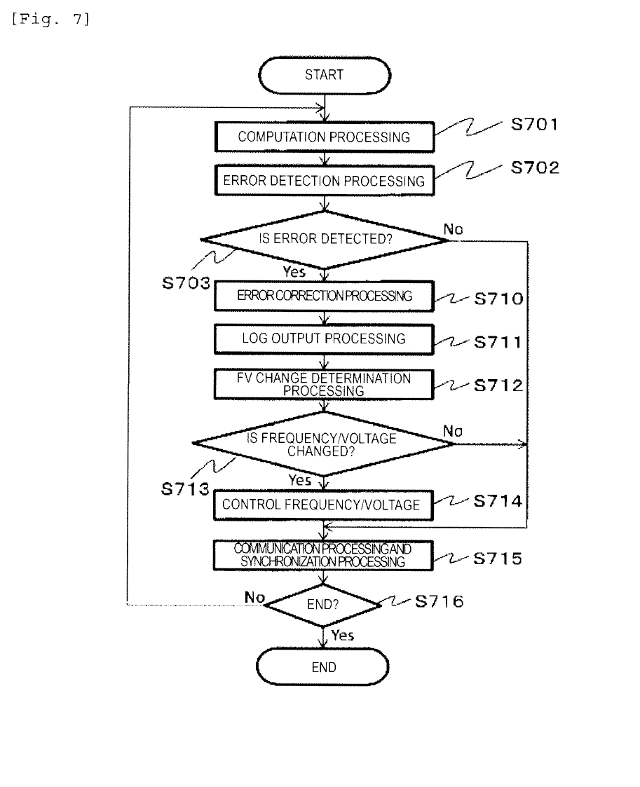

Hereinafter, operations of the computer system 100 in executing the computation in step S505 will be described in detail with reference to a flow chart in FIG 7. In addition, a repetition type converging computation, such as the K-means clustering algorithm, which is given as the main computation processing information 205, will be described as an example.

When the computing unit 321 of the worker node 120 receives a notification of a start of execution of the computation from the master node 110, the computing portion 121 which is executed by the computing unit 321 executes the allocated computation processing, and sends the computation result to the error detecting portion 122 which is executed by the auxiliary computing unit 322 (step S701). Next, with respect to the sent computation result of the computing portion 121 which is executed by the computing unit 321, the error detecting portion 122 which is executed by the auxiliary computing unit 322 performs the error detection processing (step S702), and if an error is detected, the error detecting portion 122 performs the error correction processing (step S710) and the log output processing (step S711) by the error correcting portion 123.

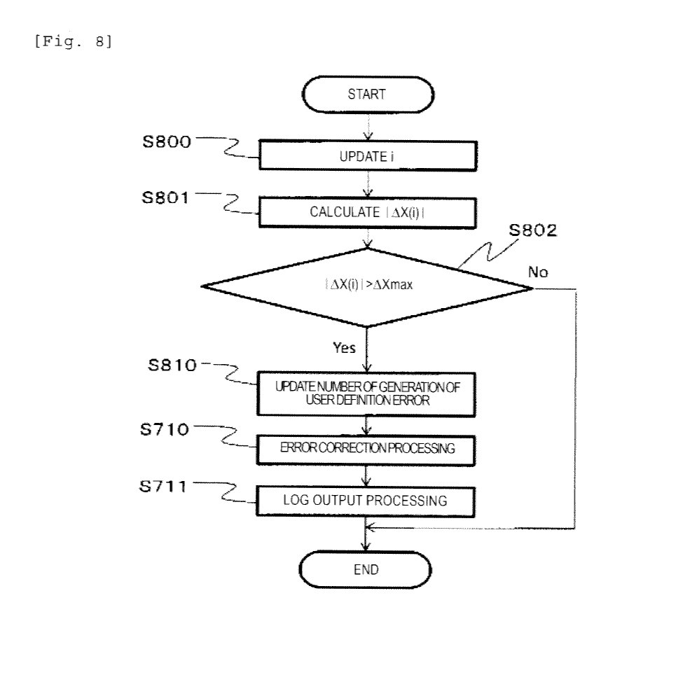

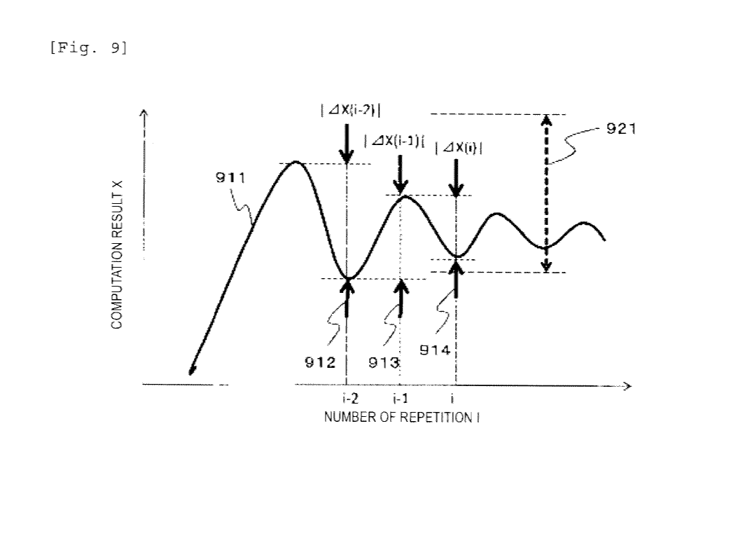

Here, an example of processing from the error detection processing S702 to the log output processing S711, will be described in detail with reference to FIGS. 8 and 9. FIG. 8 is a flow chart which corresponds to the processing from the error detection processing S702 to the log output processing S711. FIG. 9 illustrates a transition of a value of a computation result X in i times of repetition by a curved line 911, and illustrates an example in which the computation result X of repeated computation fluctuates and converges in accordance to an increase in repetition time i. Here, as an example of the error detection processing information 220 according to the invention, an overview of an algorithm (hereinafter, referred to as an error detection algorithm) which uses an absolute value of a difference between the computation result of i times of repetition and the computation result of i−1 times of repetition as the standard of determination of the computation error, will be first described, and then, the flow chart in FIG. 8 will be described. Hereinafter, the computation result of the computing portion 121 which is executed by the computing unit 321 of i times of repetition will be described as an expression X(i).

In FIG. 9, |ΔX(i−2)| corresponds to a change amount 912 of the computation result X of i−2 times of repetition, |ΔX(i−1)| corresponds to a change amount 913 of the computation result X of i−1 times of repetition, and |ΔX(i)| corresponds to a change amount 914 of the computation result X of i times of repetition. In the error detection algorithm according to the present embodiment which is executed by the error detecting portion 122, the computation result X sets an upper limit value based on the information regarding the change amount in the past, with respect to the change amount of the computation result X on the assumption that the computation result X converges in accordance with the increase in the repetition time i. Specifically, the upper limit value is set according to the following formulas (1) and (2).

|ΔX(i)|<ΔXmax Formula (1)

ΔXmax=MAX(α·|ΔX(i−1)|,β·|ΔX(i−2)|) Formula (2)

Here, as illustrated in Formula (2), ΔXmax is a larger value among a value which is α times the change amount 913 of i−1 times of repetition, and a value which is β times the change amount 912 of i−2 times of repetition, α and β are values set by the user, and are real numbers which are equal to or greater than zero. In other words, the upper limit value of the change amount 914 of i times of repetition is a larger value among the value which is α times the change amount 913 of i−1 times of repetition, and the value which is β times the change amount 912 of i−2 times of repetition. A value range of ΔX(i) which is restricted by this upper limit value setting is expressed, for example, by a value range 921, and when |ΔX(i)| exceeds the upper limit value (in another expression, when ΔX(i) is outside the range of the value range 921), the case is counted as a case where the user definition error is generated.

Here, when two results, such as the results of i−1 times of repetition and i−2 times of repetition, are used, for example, in a case where the computation error is generated after i−1 times of repetition, and |ΔX(i−1)| becomes an extremely small number, the upper limit value of |ΔX(i)| also becomes an extremely small number, and it takes a longer time to converge the computation. Here, on the assumption that a probability of generation of large computation errors two or more times in a row is low, by employing a much larger value as the upper limit value by using |ΔX(i−2)|, the above-described problem is solved. In addition, in order to further stabilize the converging time, it is possible to add conditions, for example, to further introduce |ΔX(i−3)| to Formula (1). ΔXmax in |ΔX(1)| may be set by the user, and may be a maximum value which can be obtained in a type of a variable X.

By the above-described error detection algorithm, it is possible to avoid the computation error which greatly influences the application.

Next, the flow chart in FIG. 8 will be described. When the error detecting portion 122 which is executed by the auxiliary computing unit 322 receives a computation result X(i), the error detecting portion 122 updates a value of i times of repetition (step S800). After this, the error detecting portion 122 calculates |ΔX(i)| which is an absolute value of a difference between a computation result X(i−1) of i−1 times of repetition and the computation result X(i) of i times of repetition of the computing portion 121 which is executed by the computing unit 321 (step S801), and checks whether or not |ΔX(i)| exceeds the upper limit value of the change amount shown in Formula (1) (step S802). In addition, a branch of step S602 corresponds to a branch of step S703. When the condition in Formula (1) is not satisfied in step S802, the error detecting portion 121 decides that the user definition error is generated. In addition, the number of times of generation of the user definition error is updated in the FV change determining portion 124 (step S810), and the frequency thereof is obtained as described be low.

In the error correction processing (step S710), when |ΔX(i)| exceeds the upper limit value compared to step S802, the error correcting portion 167 which is executed by the auxiliary computing unit 322 employs a value which is close to X(i) among X(i−1)+ΔXmax and X(i−1)−ΔXmax as a value of X(i) after the correction. After this, the error correcting portion 167 performs the log output processing (step S711), and sends the error log information 165, such as a state of generation of the user definition error and a value before and after the correction, to the error recording managing portion 115 of the master node 110. The processing described above is an example of the processing from the error detection processing S702 to the log output processing S711. Accordingly, since, it is possible to maintain the accuracy which is required by the application, and to permit the computation error, it is possible to set a larger range of variation in the power supply voltage and the operating frequency than that in the related art, and to perform the computation with lower power and a higher speed.

In FV change determination processing (step S712), the FV change determining portion 124 monitors the frequency of the generated user definition error in the error detection processing (step S702), and determines whether to control the operating frequency or the power supply voltage of the computing unit 321, based on the frequency of generation of the user definition error, the permissible error frequency information 240, and the operating mode setting information of the FV control processing information 250. When the operating frequency or the power supply voltage is changed, the FV change determining portion 124 sends the setting amount 169 of the operating frequency or the power supply voltage to the FV control portion 125 of the computing unit 321 (S714). An example of definition of the frequency of generation of the user definition error includes the number of times of detection of the generated user definition error per N (N is a whole number of one or more) times of error detection processing of step S702, and when this number is over the permissible error frequency information 240, the setting amount 169 which increases the power supply voltage and decreases the operating frequency is sent. Meanwhile, when the observed frequency of generation of the user definition error is below the permissible error frequency information 240, the FV change determining portion 124 sends the setting amount 169 which decreases the power supply voltage and increases the operating frequency. Accordingly, the computer system 100 can perform the processing with lower power or a higher speed.

After this, the worker node 120 sends the computation result to another worker node 120 and notifies information regarding a converging state of the computation result and completion of the computation to the master node 110, and the master node 110 performs synchronization processing (step S715). The master node 110 decides whether or not the computation result is converged, and when it is decided that the computation result is converged, the computation ends (step S715).

Above, an example of the operation of the computation processing in step S505 according to the embodiment is described.

The computer system 100 according to the embodiment can set a larger range of variation in the power supply voltage or the frequency than that in the related art, by the above-described operation, and can perform the computation with lower power or higher speed.

### Embodiment 2

In the present embodiment, a computer system 1001 will be described as an embodiment in which programming is easier than in the computer system 100 illustrated in Embodiment 1.

The computer system 1001 makes mostly used processing pattern among the error detection processing information 220, the error correction processing information 230, and the FV control processing information 250 in the computation error resistance information 201 included in the program 102 in the computer system 100 a template (in another expression, a library), and provides this to a programmer as an application program interface (API). According to this, the programmer can select the processing pattern that the programmer desires to use, and it is possible to use the function of the computer system 100 by indicating a parameter.

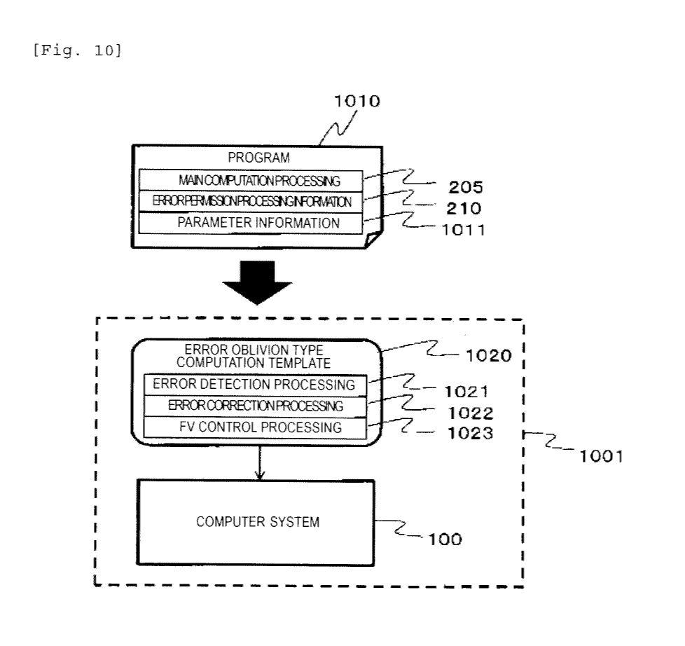

FIG. 10 is an example of a configuration diagram of the computer system 1001 according to Embodiment 2. The computer system 1001 includes an error oblivion type computation template 1020 and the computer system 100, and performs computation by considering a program 1010 as an input. The error oblivion type computation template 1020 includes an error detection processing 1021, an error correction processing 1022, and an FV control processing 1023.

For example, the error detection processing 1021 is the processing of the error detection processing information 220 which is described in Embodiment 1, and in this case, α and β in Formula (2) can be set as parameters. For example, the error correction processing 1022 is the processing of the error correction processing information 230 which is described in Embodiment 1, and another example thereof is a re-computation by a rollback. The error correction processing 1022 can set correction processing modes thereof as parameters. For example, the FV control processing 1023 is the processing of the FV control processing information 250 which is described in Embodiment 1, and can set the permissible error frequency information 240 or the operating mode setting information which indicates whether to perform a control for performing the computation with low power or a high speed, as parameters.

The program 1010 includes the main computation processing information 205, the error permission processing information 210, and parameter information 1011. The parameter information 1011 is a parameter of the error detection processing 1021, the error correction processing 1022, and the FV control processing 1023 of the error oblivion type computation template 1020, and is input into the system as a factor of the API.

The computer system 1001 creates the computation error resistance information 201 by using the error oblivion type computation template 1020, the parameter information 1011, and the error permission processing information 210, further adds and inputs the main computation processing information 205 as the program 102 into the computer system 100.

According to the description above, the computer system 1001 can set a large range of variation in the power supply voltage and the operating frequency than that in the related art, can perform computation with lower power or a higher speed, and can realize an easier program than that of the computer system 100 illustrated in Embodiment 1.

### REFERENCE SIGNS LIST

100: Computer system
102: Program
104: Input data
106: Computation result
110: Master node
111: Error resistance information obtaining portion
112: Computation allocating portion
113: Error detection/correction method setting portion
114: FV change determining unit setting portion
115: Error recording managing portion
120: Worker node
121: Computing portion
122: Error detecting portion
123: Error correcting portion
124: FV change determining portion
125: FV control portion
130: Data bus 130
310: Computation node
311: Computing unit
313: Memory unit
314: Communication unit
315: Bus
320: Computation node
321: Computing unit
322: Auxiliary computing unit
330: Network
340: Storage device

1. A control method for a computer system including a first, processor and a second processor,
wherein, in the first processor, at least one of an operating frequency or an operating voltage is variable,
wherein a detecting module which is operated by the second processor detects an error of the first processor, and
wherein a determining module which is operated by the second processor determines at least one of the operating frequency or the operating voltage of the first processor.

2. The control method for a computer system according to claim 1,
wherein, when the determining module determines at least one of the operating frequency or the operating voltage of the first processor, based on the frequency of the error which is detected by the detecting module, the determining module determines at least one of the operating frequency or the operating voltage of the first processor.

3. The control method for a computer system according to claim 2,
wherein the frequency is the number of times of detection of the generated error per the number of performing of detection processing of the error by the detecting module.

4. The control method for a computer system according to claim 1,
wherein the computer system includes a first information processing device which has the first processor and the second processor, and a second information processing device which sends a detection condition of the error to the first information processing device.

5. The control method for a computer system according to claim 4,
wherein the second information processing device extracts the detection condition from a program which is input into the computer system.

6. The control method for a computer system according to claim 4,
wherein the first information processing device and the second information processing device are server devices.

7. A computer system, comprising:
a first processor; and
a second processor,
wherein, in the first processor, at least one of an operating frequency or an operating voltage is variable,
wherein a detecting module which is operated by the second processor detects an error of the first processor, and
wherein a determining module which is operated by the second processor determines at least one of the operating frequency or the operating voltage of the first processor.

8. The computer system according to claim 7,
wherein, based on the frequency of the error which is detected by the detecting module, the determining module determines at least one of the operating frequency or the operating voltage of the first processor.

9. The computer system according to claim 8,
wherein the frequency is the number of times of detection of the generated error per the number of performing of detection processing of the error by the detecting module.

10. The computer system according to claim 1, further comprising:
a first information processing device which has the first processor and the second processor; and
a second information processing device which sends a detection condition of the error to the first information processing device.

11. The computer system according to claim 10,
wherein the second information processing device extracts the detection condition from a program which is input into the computer system.

12. The computer system according to claim 10,
wherein the first information processing device and the second information processing device are server devices.
